(19) United States
(12) Patent Application Publication
(10) Pub. No.: US 2015/0346995 A1
(43) Pub. Date: Dec. 3, 2015

(54) ELECTRONIC APPARATUS AND METHOD

(71) Applicant: KABUSHIKI KAISHA TOSHIBA, Tokyo (JP)

(72) Inventor: Chikashi Sugiura, Hamura Tokyo (JP)

(21) Appl. No.: 14/585,650

(22) Filed: Dec. 30, 2014

(30) Foreign Application Priority Data
May 28, 2014 (JP) 2014-110328

(51) Int. Cl. G06F 3/0488; G06F 3/0484

(52) U.S. Cl. CPC G06F 3/04883; G06F 3/04842

(57) ABSTRACT

According to one embodiment, an electronic apparatus includes circuitry configured to display strokes of one-line handwritten characters. The circuitry is further configured to display characters corresponding to a recognition result of the strokes in a third direction. The third direction is determined based on a first direction of the one-line and a second direction determined based on at least one vector direction of at least one stroke.

### CROSS-REFERENCE TO RELATED APPLICATIONS

This application is based upon and claims the benefit of priority from Japanese Patent Application No. 2014-110328, filed May 28, 2014, the entire contents of which are incorporated herein by reference.

### FIELD

Embodiments described herein relate generally to a technique for inputting characters in handwriting.

### BACKGROUND

Recently, various types of electronic devices such as tablet computers, PDAs and smartphones have been developed. Most of these devices include a touch screen display for facilitating the input operation by the user. Some of the devices have a handwriting function. By using such devices, the user can prepare a document which includes text and images as well as handwritten characters and drawings.

For example, in some cases, handwritten characters are converted into text (character codes) by various character recognition processes so that the characters can be used in a different application program.

However, characters are not always handwritten in a single direction on the screen of a touch screen display, and may be handwritten in various directions. In the characters handwritten in various directions, accuracy of character recognition may be reduced.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective illustration showing an external appearance of an electronic apparatus according to an embodiment.

FIG. 2 shows examples of strokes which are handwritten on a touch screen display of the electronic apparatus according to the embodiment.

FIG. 3 is a diagram for explaining an example of time-series data (stroke data) which corresponds to the handwritten strokes of FIG. 2 and is stored in a storage medium by the electronic apparatus according to the embodiment.

FIG. 4 is an exemplary block diagram showing a system configuration of the electronic apparatus according to the embodiment.

FIG. 5 is an exemplary block diagram showing a function configuration of a digital notebook application program executed by the electronic apparatus according to the embodiment.

FIG. 6 is a diagram for explaining an example in which lines of characters handwritten on the touch screen display of the electronic apparatus are normalized according to the embodiment.

FIG. 7 is a diagram for explaining another example in which lines of characters handwritten on the touch screen display of the electronic apparatus are normalized according to the embodiment.

FIG. 8 shows an example of lines of characters normalized by the electronic apparatus according to the embodiment.

FIG. 9 shows an example of vectors from starting points to end points of strokes contained in the lines of FIG. 8.

FIG. 10 shows another example of lines of characters normalized by the electronic apparatus according to the embodiment.

FIG. 11 shows an example of vectors from starting points to end points of strokes contained in the lines of FIG. 10.

FIG. 12 is an exemplary flowchart showing steps of a handwriting input process executed by the electronic apparatus according to the embodiment.

FIG. 13 is an exemplary flowchart showing steps of a handwritten character recognition process executed by the electronic apparatus according to the embodiment.

FIG. 14 is an exemplary flowchart showing other steps of the handwritten character recognition process executed by the electronic apparatus according to the embodiment.

### DETAILED DESCRIPTION

Various embodiments will be described hereinafter with reference to the accompanying drawings. In general, according to one embodiment, an electronic apparatus includes circuitry configured to display strokes of one-line handwritten characters. The circuitry is further configured to display characters corresponding to a recognition result of the strokes in a third direction. The third direction is determined based on a first direction of the one-line and a second direction determined based on at least one vector direction of at least one stroke.

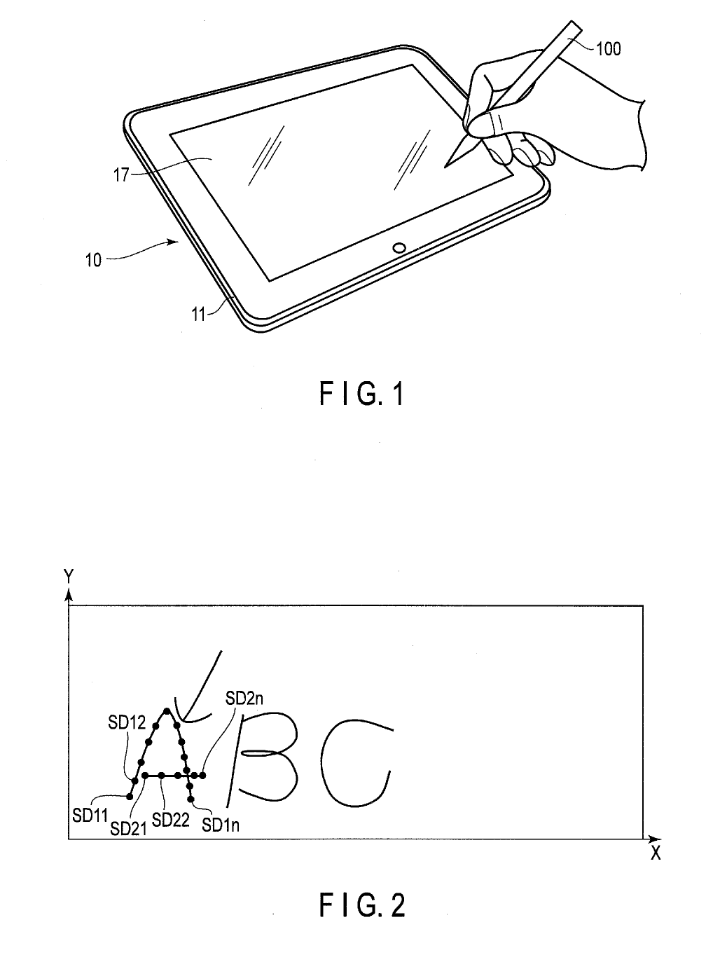

FIG. 1 is a perspective illustration showing an external appearance of an electronic apparatus according to an embodiment. The electronic apparatus is, for example, a stylus-based portable electronic apparatus which enables handwriting input by a stylus or a finger. The electronic apparatus may be realized as a tablet computer, a notebook computer, a smartphone, a PDA and the like. Hereinafter, the electronic apparatus is assumed to be realized as a tablet computer 10. The tablet computer 10 is a portable electronic apparatus which is also referred to as a tablet or a slate computer. As shown in FIG. 1, the tablet computer 10 includes a main body 11 and a touch screen display 17. The touch screen display 17 is attached to an upper surface of the main body 11 such that the touch screen display 17 overlaps with the upper surface of the main body 11.

The main body 11 includes a housing having a thin-box shape. The touch screen display 17 incorporates a flat-panel display, and a sensor to detect the contact position on the screen of the flat-panel display with a stylus or a finger. The flat-panel display may be, for example, a liquid crystal display (LCD) device. As the sensor, for example, a capacitive touch panel or an electromagnetic-induction-type digitizer can be employed. Hereinafter, it is assumed that the touch screen display 17 incorporates both of the two types of sensors, which are a digitizer and a touch panel.

Each of the digitizer and the touch panel is provided in order to cover the screen of the flat-panel display. The touch screen display 17 can detect a touch operation on the screen by using a finger as well as a touch operation on the screen by using a stylus 100. The stylus 100 is, for example, an electromagnetic induction stylus.

The user can conduct a handwriting input operation which inputs strokes in handwriting on the touch screen display 17 by using an external object (the stylus 100 or a finger). During the handwriting input operation, the path of movement of the external object (the stylus 100 or the finger) on the screen is drawn in real time. In other words, the path (trace) of a stroke handwritten by the handwriting input operation is drawn in real time. Thus, the path of each stroke is displayed on the screen. The path of movement of the external object contacting the screen is equivalent to a stroke. The assembly of many strokes, or in other words, the assembly of many paths (traces) constitutes handwritten characters, drawings and the like.

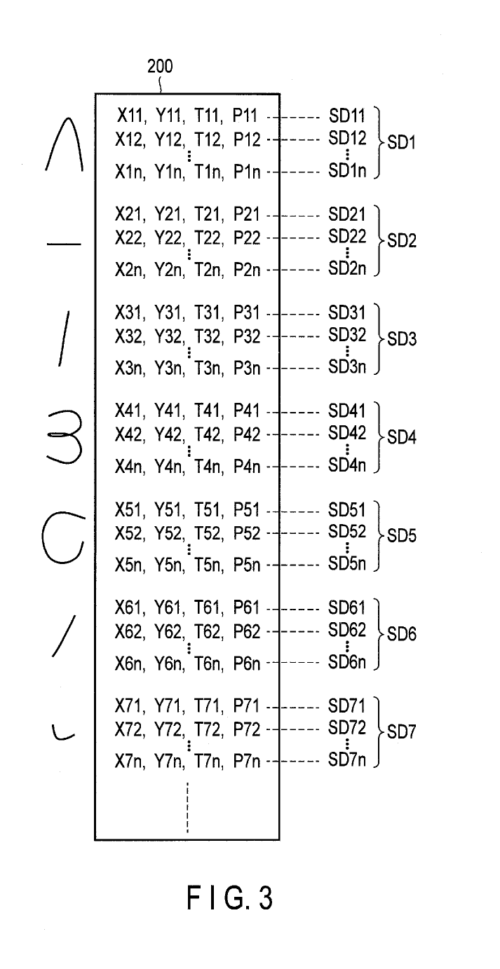

In this embodiment, in the storage medium, handwritten strokes (handwritten characters and drawings) are not stored as image data. Instead, in the storage medium, handwritten strokes are stored as time-series data indicating the coordinate sequences of paths of strokes and the order relationship of strokes. The time-series data is explained in detail later with reference to FIG. 3. Roughly, the time-series data refers to the assembly of time-series stroke data items corresponding to a plurality of strokes respectively. Each stroke data item may be any data item as long as it can indicate one stroke which can be input in handwriting. For example, a stroke data item includes a series of coordinate data items (time-series coordinates) corresponding to points on the path of the stroke respectively. The order of stroke data items is equivalent to the order in which the strokes are handwritten, or in sum, the order of strokes.

The tablet computer 10 can read arbitrary existing document data from the storage medium, and display a document corresponding to the document data on the screen. In other words, on the screen, the tablet computer 10 can display a handwritten document in which paths corresponding to a plurality of strokes indicated by time-series data respectively are drawn.

Next, the relationship between strokes handwritten by the user (handwritten characters, marks, drawings, charts and the like) and time-series data, will be explained referring to FIG. 2 and FIG. 3. FIG. 2 shows an example of a document handwritten on the touch screen display 17 by using the stylus, 100, etc.

In this document, in many cases, a different character or drawing is handwritten on an already-handwritten character or drawing. FIG. 2 assumes the following case: the character string “ABC” is handwritten in the order of “A”, “B” and “C”, and after that, an arrow is handwritten in proximity to the handwritten character “A”.

The handwritten character “A” is shown by two strokes (a stroke having a “Λ” shape and a stroke having a “-” shape) handwritten by using the stylus 100, etc., or in other words, is shown by two paths. For example, the path of the stylus 100 regarding the “Λ” shape which is firstly handwritten is sampled in real time at regular time intervals. Thus, time-series coordinates (SD11, SD12, . . . , SD1n) of the stroke having the “Λ” shape are obtained. In a similar manner, the path of the stylus 100 regarding the “-” shape which is secondly handwritten is sampled. Thus, time-series coordinates (SD21, SD22, . . . , SD2n) of the stroke having the “-” shape are obtained.

The handwritten character “B” is shown by two strokes handwritten by using the stylus 100, etc., or in other words, is shown by two paths. The handwritten character “C” is shown by one stroke handwritten by using the stylus 100, etc., or in other words, is shown by one path. The handwritten arrow is shown by two strokes handwritten by using the stylus 100, etc., or in other words, two paths.

FIG. 3 shows time-series data 200 corresponding to the document of FIG. 2. The time-series data 200 includes a plurality of stroke data items (SD1, SD2, . . . , SD7). In the time-series data 200, stroke data items SD1, SD2, . . . , SD7 are arranged in the order of strokes, or in other words, in chronological order in which the stokes are handwritten.

In the time-series data 200, the initial two stroke data items SD1 and SD2 show two strokes of the handwritten character “A” respectively. The third and fourth stroke data items SD3 and SD4 show two strokes constituting the handwritten character “B” respectively. The fifth stroke data item SD5 shows one stroke constituting the handwritten character “C”. The sixth and seventh stroke data items SD6 and SD7 show two strokes constituting the handwritten arrow respectively.

Each stroke data item includes a series of coordinate data items (time-series coordinates) corresponding to one stroke. In other words, each stroke data item includes a plurality of coordinates corresponding to a plurality of points on the path of one stroke respectively. In each stroke data item, a plurality of coordinates are arranged in chronological order in line with the order in which the stroke is handwritten. For example, regarding the handwritten character “A”, stroke data item SD1 includes a series of coordinate data items (time-series coordinates) corresponding to points on the path of the stroke having the “Λ” shape of the handwritten character “A”, or in other words, includes n coordinate data items (SD11, SD12, . . . , SD1n). Stroke data item SD2 includes a series of coordinate data items corresponding to points on the path of the stroke having the “-” shape of the handwritten character “A” respectively, or in other words, includes n coordinate data items (SD21, SD22, . . . , SD2n). The number of coordinate data items (n) may differ depending on the stroke data item.

Each coordinate data item indicates the X coordinate and the Y coordinate of a point on the corresponding path. For example, coordinate data item SD11 indicates the X coordinate (X11) and the Y coordinate (Y11) of the starting point of the stroke having the “Λ” shape. Coordinate data item SD1n indicates the X coordinate (X1n) and the Y coordinate (Y1n) of the end point of the stroke having the “Λ” shape.

Each coordinate data item may further include timestamp data T corresponding to the time when the point corresponding to the coordinate of the data item is handwritten. The time may be either an absolute time (for example, year/month/day/hour/minute/second) or a relative time based on a time point. For example, to each stroke data item, the absolute time (for example, year/month/day/hour/minute/second) when the user started writing the stroke may be added as timestamp data. Moreover, to each coordinate data item included in a stroke data item, the relative time showing the difference from the absolute time may be added as timestamp data T. By using time-series data in which timestamp data T is added to each coordinate data item, it is possible to more accurately show the temporal relationship of strokes.

Furthermore, each coordinate data item may include a pressure P which is generated by contact on the screen with an external object (for example, the stylus 100) when the point corresponding to the coordinate is handwritten.

In the present embodiment, as described above, handwritten strokes are not stored as images or character recognition results. Instead, handwritten strokes are stored as the time-series data 200 structured by the assembly of time-series stroke data items. Therefore, handwritten characters and drawings can be handled without relying on languages. Thus, according to the present embodiment, the structure of the time-series data 200 can be used in various countries in the world in common even if they use different languages.

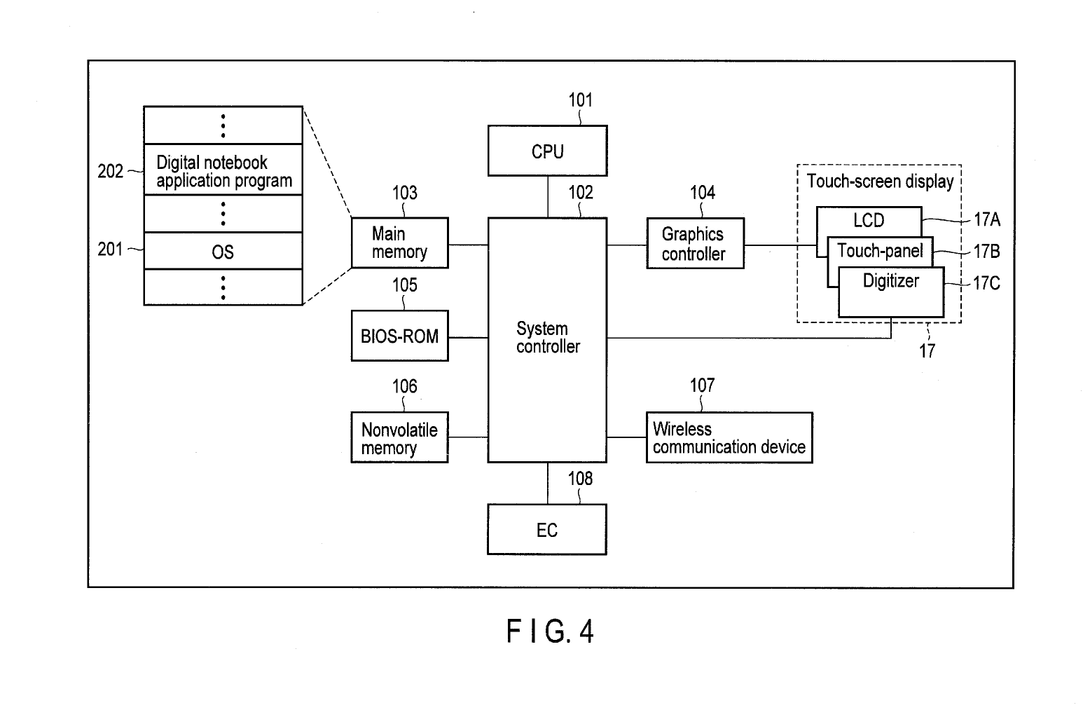

FIG. 4 shows a system configuration of the tablet computer 10.

As shown in FIG. 4, the tablet computer 10 includes a CPU 101, a system controller 102, a main memory 103, a graphics controller 104, a BIOS-ROM 105, a nonvolatile memory 106, a wireless communication device 107, an embedded controller (EC) 108 and the like.

The CPU 101 is a processor circuitry to control operations of various components of the tablet computer 10. The CPU 101 executes various types of software loaded from the nonvolatile memory 106 which is a storage device into the main memory 103. The software includes an operating system (OS) 201 and various application programs. The application programs include a digital notebook application program 202. The digital notebook application program 202 has a character recognition function which recognizes a character corresponding to at least one handwritten stroke.

The CPU 101 also executes a basic input/output system (BIOS) stored in the BIOS-ROM 105. The BIOS is a program for hardware control.

The system controller 102 is a device to connect a local bus of the CPU 101 and various components. The system controller 102 includes a built-in memory controller to control the access of the main memory 103. The system controller 102 has a function for executing communication with the graphics controller 104 via a serial bus compatible with PCI EXPRESS standards.

The graphics controller 104 is a display controller to control an LCD 17A used as a display monitor of the tablet computer 10. A display signal produced by the graphics controller 104 is transmitted to the LCD 17A. The LCD 17A displays a screen image based on the display signal. A touch panel 17B and a digitizer 17C are provided on the LCD 17A. The touch panel 17B is a capacitive pointing device for inputting data on the screen of the LCD 17A. The touch panel 17B detects the contact position on the screen with a finger, the movement of the position and the like. The digitizer 17C is an electromagnetic-induction-type pointing device for inputting data on the screen of the LCD 17A. The digitizer 17C detects the contact position on the screen with the stylus 100, the movement of the position, the contact pressure and the like.

The wireless communication device 107 is a device to perform wireless communication by using a wireless LAN or 3G mobile communications. The EC 108 is a one-chip microcomputer including an embedded controller for power management. The EC 108 has a function for turning on or off the tablet computer 10 in accordance with the operation of a power button by the user.

As stated above, the user inputs strokes constituting characters in handwriting into a handwritten document displayed on the screen of the touch screen display 17. A character recognition process is applied by the digital notebook application program 202 to the stroke data corresponding to the input strokes. Through this process, the stroke data is converted into characters.

The user can handwrite a line containing strokes in an arbitrary direction in a handwritten document. Characters consisting of strokes in a line are handwritten vertically or horizontally. In sum, in a handwritten document, strokes are handwritten in a line having an arbitrary direction. Further, in the handwritten document, a line containing vertically-written characters and a line containing horizontally-written characters could be mixed. In a character recognition process, for example, strokes in a handwritten document are recognized as characters for each line. When a character recognition process is applied to strokes in a line on the premise of a predetermined line structure (for example, on the premise that a line is handwritten in a certain direction and a character is handwritten in a certain direction), characters may not be appropriately recognized.

In consideration of the above factors, the present embodiment determines whether a line which has an arbitrary direction and contains at least one stroke handwritten in a handwritten document is described vertically or horizontally, and conducts character recognition in accordance with the determination. In the present embodiment, for example, a character corresponding to at least one stroke is recognized (displayed) based on a third direction (vertically or horizontally), in which a character is described. The third direction is determined by using a first direction and a second direction. The first direction is the direction in which one line in a handwritten document is handwritten. The second direction is the direction of at least one stroke corresponding to at least one vector from the starting point to the end point of each stroke. By using the direction in which the line is handwritten, and the vector from the starting point to the end point of each stroke, it is possible to determine whether the line is described vertically or horizontally with high accuracy. Thus, handwritten characters can be appropriately recognized.

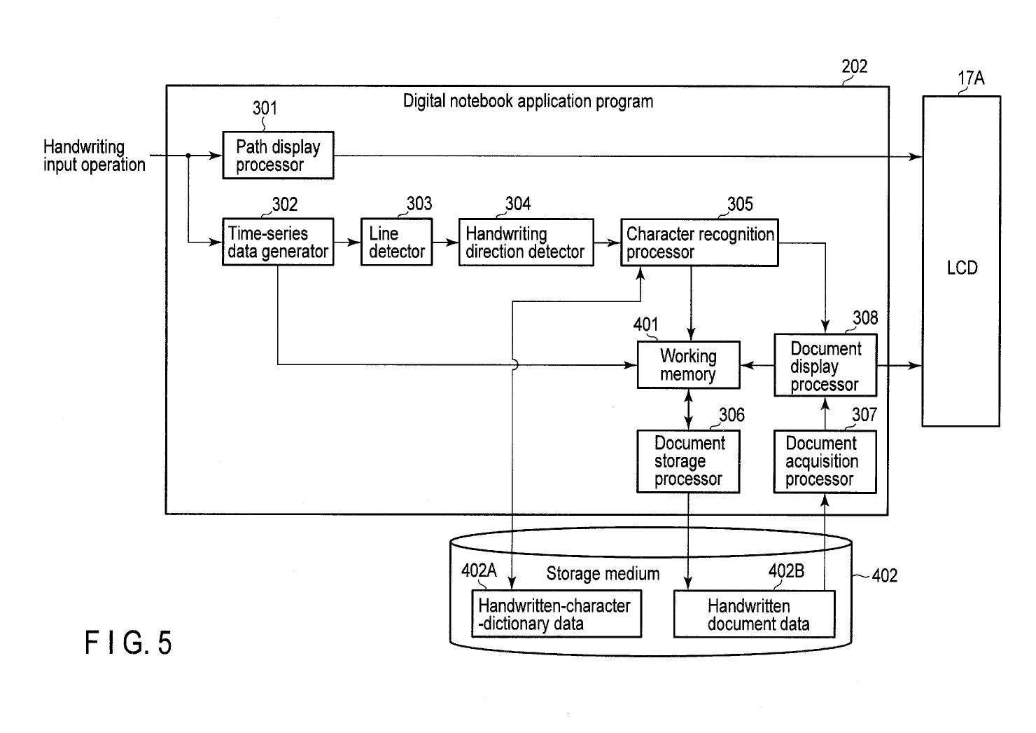

FIG. 5 shows an example of the function configuration of the digital notebook application program 202 executed by the tablet computer 10. The digital notebook application program 202 recognizes characters from time-series data (stroke data) input by the operation using the touch screen display 17.

The digital notebook application program 202 includes, for example, a path display processor 301, a time-series data generator 302, a line detector 303, a handwriting direction detector 304, a character recognition processor 305, a document storage processor 306, a document acquisition processor 307 and a document display processor 308.

The touch screen display 17 detects the generation of an event such as “touch”, “move (slide)” and “release”. The event “touch” is an event indicating that an external object contacts the screen. The event “move (slide)” is an event indicating that the contact position is moved while the external object contacts the screen. The event “release” is an event indicating that the external object is released from the screen.

The path display processor 301 and the time-series data generator 302 receive the event “touch”, “move (slide)” or “release” generated by the touch screen display 17, and detect a handwriting input operation through the reception. The event “touch” includes the coordinate of the contact position. The event “move (slide)” includes the coordinate of the move destination contact position. The event “release” includes the coordinate of the position in which the contact position is released from the screen. Thus, the path display processor 301 and the time-series data generator 302 can receive the coordinate sequence corresponding to the path of movement of the contact position from the touch screen display 17.

The path display processor 301 displays at least one stroke which is input in handwriting on the screen of the touch screen display 17. The path display processor 301 receives the coordinate sequence from the touch screen display 17. Based on the coordinate sequence, the path display processor 301 displays the path of each stroke which is handwritten by a handwriting input operation using the stylus 100, etc., on the screen of the LCD 17A of the touch screen display 17. By the path display processor 301, the path of the stylus 100 contacting the screen, or in other words, a stroke, is drawn on the screen of the LCD 17A.

The time-series data generator 302 receives the above-described coordinate sequence which is output from the touch screen display 17, and generates time-series data (stroke data) having the structure explained in FIG. 3 based on the coordinate sequence. In this case, the time-series data, which is data of coordinates corresponding to points of strokes and timestamp data, may be temporarily stored in a working memory 401. The time-series data generator 302 outputs the generated time-series data (stroke data) to the line detector 303. In accordance with a request for character recognition of a displayed handwritten document, the line detector 303 may read time-series data corresponding to the handwritten document from the working memory 401 and a storage medium 402.

The path display processor 301 and the time-series data generator 302 may receive, from various types of pointing devices such as a mouse, a pen mouse and a touchpad, the position on the screen of the display, and the coordinate sequence corresponding to the path of movement of the position. In this case, the path display processor 301 displays at least one stroke which is input in handwriting on the screen by using a pointing device. The time-series data generator 302 receives the coordinate sequence which is output from the pointing device, and generates time-series data (stroke data) having the structure explained in FIG. 3 based on the coordinate sequence.

Strokes which are input in handwriting on the screen of the display 17 constitute a line in a handwritten document. For example, the user can handwrite a line containing strokes in an arbitrary direction in a handwritten document. The path display processor 301 displays at least one stroke which is input in handwriting on the screen of the display 17 and which corresponds to one line containing a plurality of characters in a handwritten document.

The line detector 303, the handwriting direction detector 304, the character recognition processor 305 and the document display processor 308 display a character corresponding to a recognition result of at least one stroke on the screen based on the third direction, in which a character is described. The third direction is determined by using the first direction, in which one line in a handwritten document is handwritten, and the second direction, which is the direction of at least one stroke corresponding to the vector from the starting point to the end point of each stroke. As a pre-process of a handwritten character recognition process, the line detector 303 and the handwriting direction detector 304 determine whether a line which has an arbitrary direction and contains handwritten characters is described vertically or horizontally.

More specifically, the line detector 303 detects a line in a handwritten document by using stroke data corresponding to strokes which are input in handwriting. For example, when adjacent strokes in chronological order are within the range of a threshold value, the line detector 303 determines that the strokes are contained in one line.

Based on the strokes contained in the detected line, the handwriting direction detector 304 normalizes the line. This normalization shows that the line (or each stroke in the line) is rotated such that the direction in which the line (or each character in the line) is handwritten in the handwritten document is a defined direction. The handwriting direction detector 304 rotates the strokes by using coordinate data sequences corresponding to the time-series strokes in the line respectively such that the direction in which the line is handwritten in the handwritten document is a direction defined in advance as normalization. In order to simplify the explanation, hereinafter, it is assumed that a line handwritten from left to right is defined as a normalized line.

For example, when a line (or each character in a line) is handwritten from left to right, each stroke in the line is regarded as already normalized, and thus, the handwriting direction detector 304 does not rotate the strokes. For example, when a line (or each character in a line) is handwritten from top to bottom, the handwriting direction detector 304 normalizes the line by rotating the strokes in the line 90 degrees counterclockwise.

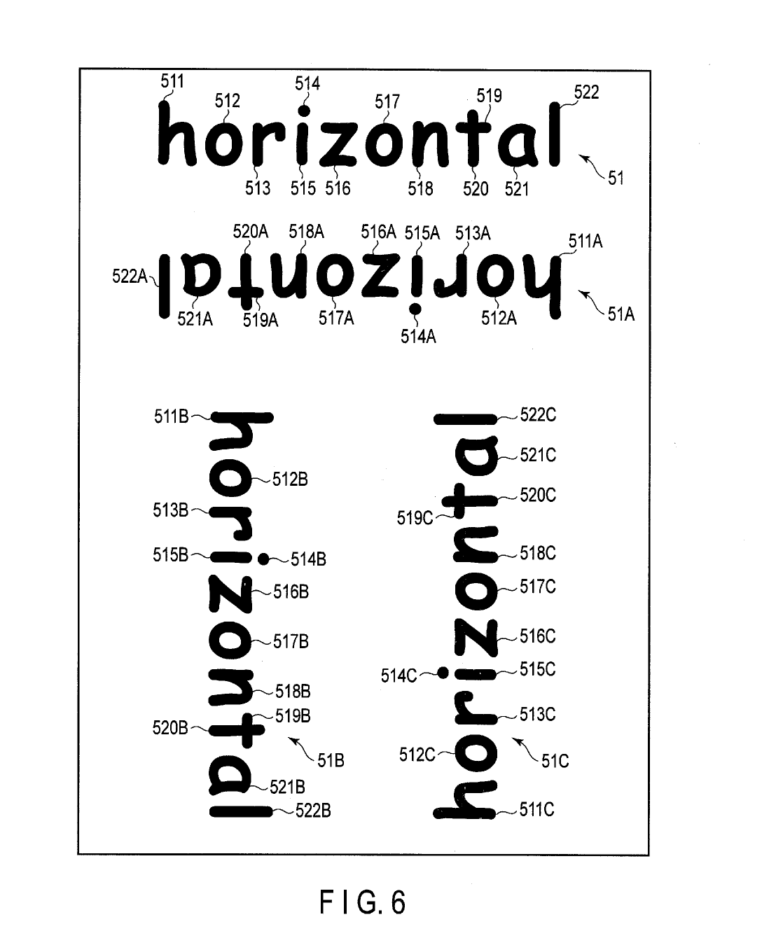

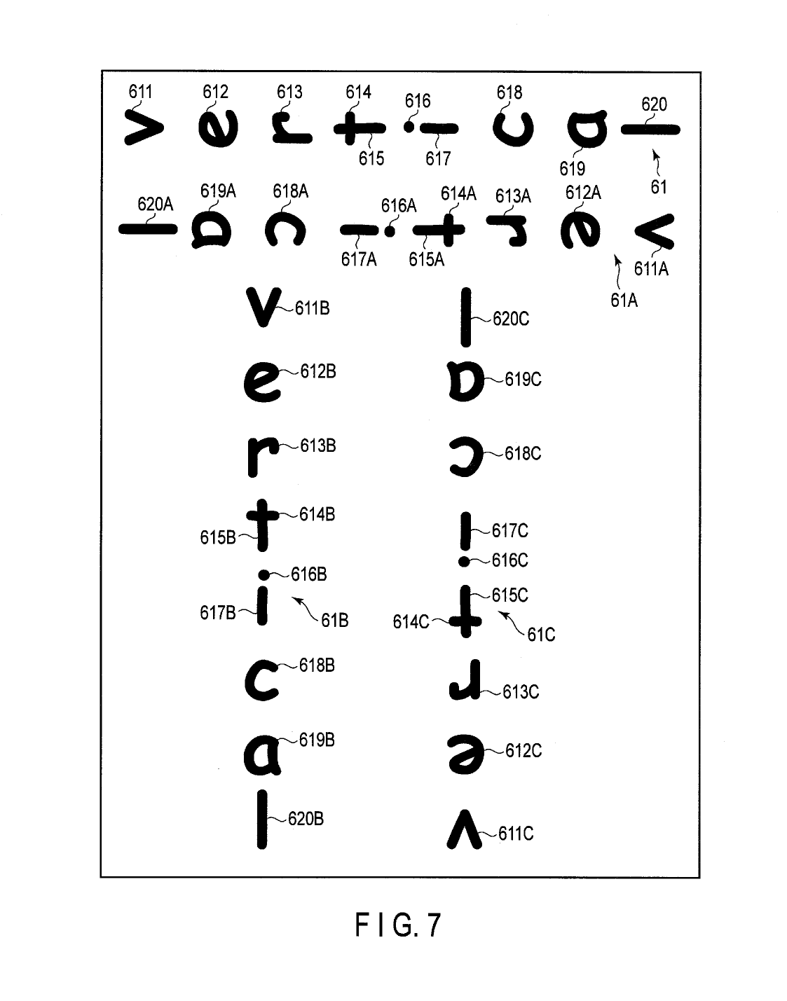

With reference to FIG. 6 and FIG. 7, examples in which lines handwritten in various directions are normalized, will be explained.

In the handwritten document shown in FIG. 6, normalized line 51, and unnormalized lines 51A, 51B and 51C are handwritten. Since normalized line 51 is handwritten in the order of stroke 511, stroke 512, stroke 513, . . . , stroke 522, normalized line 51 is a line handwritten in the direction defined in advance as normalization (here, from left to right). Therefore, the handwriting direction detector 304 does not apply a process for normalization to line 51.

On the other hand, unnormalized lines 51A, 51B and 51C are normalized by the handwriting direction detector 304.

More specifically, since line 51A is handwritten in the order of stroke 511A, stroke 512A, stroke 513A, . . . , and stroke 522A, line 51A is a line handwritten from right to left in the handwritten document. Therefore, the handwriting direction detector 304 normalizes line 51A by rotating line 51A 180 degrees counterclockwise or clockwise.

Since line 51B is handwritten in the order of stroke 511B, stroke 512B, stroke 513B, . . . , and stroke 522B, line 51B is a line handwritten from top to bottom in the handwritten document. Therefore, the handwriting direction detector 304 normalizes line 51B by rotating line 51B 90 degrees counterclockwise.

Since line 51C is handwritten in the order of stroke 511C, stroke 512C, stroke 513C, . . . , and stroke 522C, line 51C is a line handwritten from bottom to top in the handwritten document. Therefore, the handwriting direction detector 304 normalizes line 51C by rotating line 51C 270 degrees counterclockwise or 90 degrees clockwise.

In the example shown in FIG. 7, normalized line 61, and unnormalized lines 61A, 61B and 61C are handwritten. Since normalized line 61 is handwritten in the order of stroke 611, stroke 612, stroke 613, . . . , stroke 620, normalized line 61 is a line handwritten in the direction defined in advance as normalization (here, from left to right). Therefore, the handwriting direction detector 304 does not apply a process for normalization to line 61.

On the other hand, unnormalized lines 61A, 61B and 61C are normalized by the handwriting direction detector 304.

More specifically, since line 61A is handwritten in the order of stroke 611A, stroke 612A, stroke 613A, . . . , and stroke 620A, line 61A is a line handwritten from right to left in the handwritten document. Therefore, the handwriting direction detector 304 normalizes line 61A by rotating line 61A 180 degrees counterclockwise or clockwise.

Since line 61B is handwritten in the order of stroke 611B, stroke 612B, stroke 613B, . . . , and stroke 620B, line 61B is a line handwritten from top to bottom in the handwritten document. Therefore, the handwriting direction detector 304 normalizes line 61B by rotating line 61B 90 degrees counterclockwise.

Since line 61C is handwritten in the order of stroke 611C, stroke 612C, stroke 613C, . . . , and stroke 620C, line 61C is a line handwritten from bottom to top in the handwritten document. The handwriting direction detector 304 normalizes line 61C by rotating line 61C 270 degrees counterclockwise or 90 degrees clockwise.

In the examples of FIG. 6 and FIG. 7, the directions of the handwritten lines differ by 90 degrees. However, the handwriting direction detector 304 can normalize a line handwritten at an arbitrary angle in a similar manner.

Next, the handwriting direction detector 304 calculates the vector from the starting point to the end point of each stroke in a normalized line (in sum, the direction component of each stroke). In other words, the handwriting direction detector 304 calculates the vector from the coordinate of the starting point to the coordinate of the end point by using stroke data corresponding to each stroke included in a line.

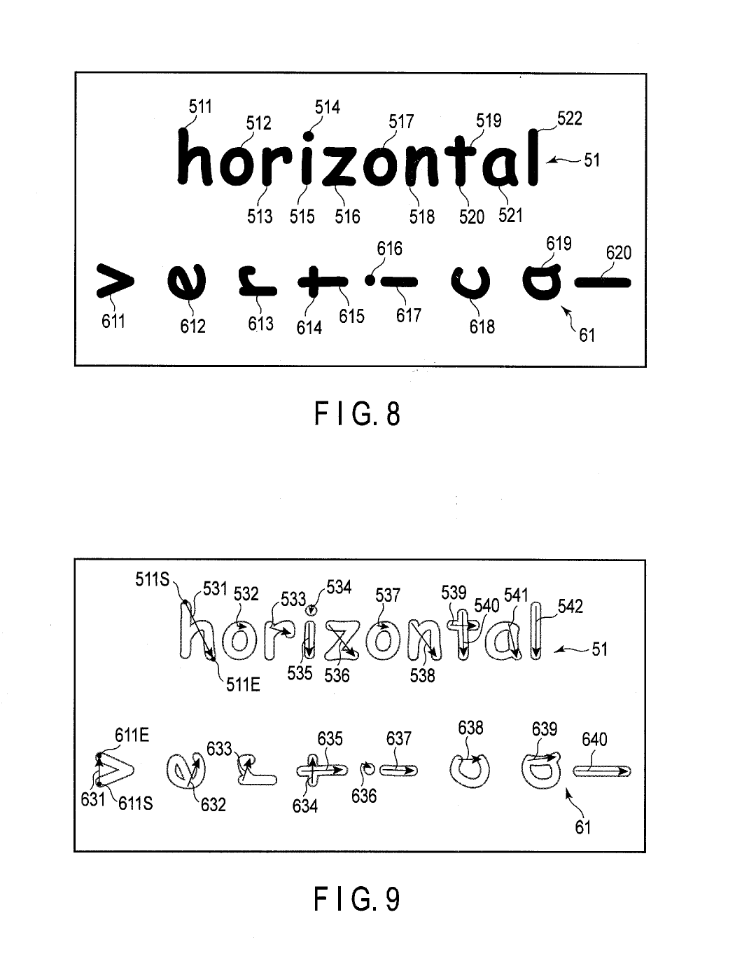

Examples of calculation of the vector from the starting point to the end point of a stroke, will be explained referring to FIG. 8 and FIG. 9. The strokes shown in FIG. 8 and FIG. 9 are strokes constituting alphabetic characters.

In the example shown in FIG. 8, line 51 containing strokes 511 to 522, and line 61 containing strokes 611 to 620 are handwritten in a handwritten document. As line 51 is handwritten in the order of stroke 511, stroke 512, stroke 513, . . . , stroke 522, line 51 is handwritten from left to right. As line 61 is handwritten in the order of stroke 611, stroke 612, stroke 613, . . . , stroke 620, line 61 is also handwritten from left to right. Thus, both line 51 and line 61 are handwritten from left to right (in other words, the lines are handwritten in the direction defined as normalization). Therefore, line 51 and line 61 are regarded as normalized lines.

As shown in FIG. 9, the handwriting direction detector 304 calculates vectors 531 to 542 corresponding to strokes 511 to 522 contained in normalized line 51. Each of vectors 531 to 542 is the vector from the starting point to the end point of the corresponding stroke. The handwriting direction detector 304 calculates vectors 631 to 640 corresponding to strokes 611 to 620 contained in normalized line 61. Each of vectors 631 to 640 is the vector from the starting point to the end point of the corresponding stroke. For example, the handwriting detector 304 calculates vector 531, which is the vector from starting point 511S to end point 511E of stroke 511. For example, the handwriting direction detector 304 calculates vector 631, which is the vector from starting point 611S to end point 611E of stroke 611. In this manner, the handwriting direction detector 304 calculates vectors corresponding to strokes in a normalized line respectively.

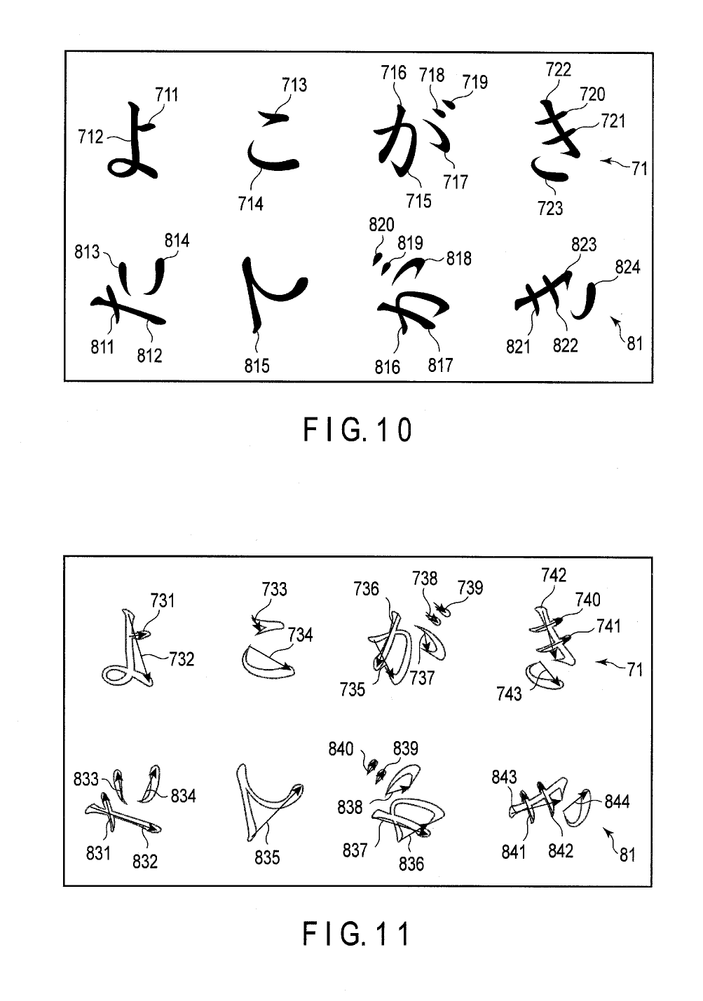

FIG. 10 and FIG. 11 show other examples of calculation of the vector from the starting point to the end point of a stroke. The strokes shown in FIG. 10 and FIG. 11 are strokes constituting Japanese characters.

In the example shown in FIG. 10, line 71 containing strokes 711 to 723, and line 81 containing strokes 811 to 824 are handwritten in a handwritten document. As line 71 is handwritten in the order of stroke 711, stroke 712, stroke 713, . . . , stroke 723, line 71 is handwritten from left to right. As line 81 is handwritten in the order of stroke 811, stroke 812, stroke 813, . . . , stroke 824, line 81 is also handwritten from left to right. Thus, both line 71 and line 81 are handwritten from left to right. Therefore, line 71 and line 81 are regarded as normalized lines.

As shown in FIG. 11, the handwriting direction detector 304 calculates vectors 731 to 743 corresponding to strokes 711 to 723 contained in normalized line 71. Each of vectors 731 to 743 is the vector from the starting point to the end point of the corresponding stroke. The handwriting direction detector 304 calculates vectors 831 to 844 corresponding to strokes 811 to 824 contained in normalized line 81. Each of vectors 831 to 844 is the vector from the starting point to the end point of the corresponding stroke.

In sum, by using stroke data (time-series data) corresponding to handwritten strokes, the handwriting direction detector 304 can calculate vectors which correspond to strokes contained in a normalized line and which are the vectors from the starting points to the end points of the strokes regardless of the type of characters consisting of the strokes.

Next, by using the calculated vectors, the handwriting direction detector 304 determines whether the characters in the line are described vertically or horizontally. The handwriting direction detector 304 determines the third direction, in which characters are described, when the first direction, which is the direction of the line, is normalized. The third direction is determined by using the second direction, which is the direction of at least one stroke corresponding to the vector from the starting point to the end point of each stroke. Hereinafter, some configuration examples of determination of whether characters in a line are described vertically or horizontally, will be described.

As a first example, the handwriting direction detector 304 calculates a resultant vector by combining vectors corresponding to strokes in a line. Based on the direction of the calculated resultant vector, the handwriting direction detector 304 determines whether characters in the line are written vertically or horizontally. When the direction of the resultant vector is downward in the handwritten document, the handwriting direction detector 304 determines that the line is written horizontally. When the direction of the resultant vector is not downward in the handwritten document, that is, when the direction is upward, the handwriting direction detector 304 determines that the line is written vertically. In other words, when the direction of the line (the first direction) is from left to right, and the direction of at least one stroke corresponding to the vector from the starting point to the end point of each stroke (the second direction) is downward, the handwriting direction detector 304 determines that the third direction, in which characters are described, is horizontal. When the direction of the line (the first direction) is from left to right, and the direction of at least one stroke corresponding to the vector from the starting point to the end point of each stroke (the second direction) is upward, the handwriting direction detector 304 determines that the third direction, in which characters are described, is vertical.

More specifically, based on whether the perpendicular component of the calculated resultant vector is positive or negative, the handwriting direction detector 304 determines whether the characters in the line are written vertically or horizontally. When the perpendicular component of the resultant vector is negative, the handwriting direction detector 304 determines that the line is described horizontally. When the perpendicular component of the resultant vector is positive, the handwriting direction detector 304 determines that the line is described vertically.

When the direction of the resultant vector is right-downward or left-downward in the handwritten document, the handwriting direction detector 304 may determine that the line is described horizontally. When the direction of the resultant vector is right-upward or left-upward in the handwritten document, the handwriting direction detector 304 may determine that the line is described vertically. In other words, when the direction of the line (the first direction) is from left to right, and the direction of at least one stroke corresponding to the vector from the starting point to the end point of each stroke (the second direction) is right-downward or left-downward, the handwriting direction detector 304 may determine that the third direction, in which characters are described, is horizontal. When the direction of the line (the first direction) is from left to right, and the direction of at least one stroke corresponding to the vector from the starting point to the end point of each stroke (the second direction) is right-upward or left-upward, the handwriting direction detector 304 may determine that the third direction, in which characters are described, is vertical.

When calculating the resultant vector, the handwriting direction detector 304 may combine vectors by weighting the vectors with weight based on the length or the feature of shape of each of strokes corresponding to the vectors. For example, the longer the stroke is, the larger value is set in the weight. Further, the more complicated the shape of the stroke is (for example, the larger the change of the direction of the stroke is), the smaller value is set in the weight. The simpler the shape of the stroke is, the larger value is set in the weight.

When the direction of the resultant vector is close to the horizontal direction, and determination of whether the line is described vertically or horizontally is ambiguous (for example, when the perpendicular component of the resultant vector is within a predetermined range including zero), the handwriting direction detector 304 may suspend the determination. After the confirmation of determination results showing whether the other lines in the handwritten document are described vertically or horizontally, the handwriting direction detector 304 determines whether the line whose determination is suspended is described vertically or horizontally by using the determination results of the other lines. For example, as the determination result of the line whose determination is suspended, the handwriting direction detector 304 adopts the dominant direction in the determination results of the other lines in the handwritten document. When neither vertical writing nor horizontal writing is dominant in the determination results of the other lines, the handwriting direction detector 304 may adopt the determination based on the resultant vector. Thus, when the resultant vector has a substantially-horizontal direction, it is possible to reduce errors regarding the determination of whether the characters in the line are written vertically or horizontally.

Moreover, when determination of whether the line is described vertically or horizontally is ambiguous, the handwriting direction detector 304 may adopt the direction set in advance (default value) out of a vertical direction and a horizontal direction. For example, the user can use a setting screen and select in advance which should be adopted, a vertical direction or a horizontal direction, in case that determination of whether the line is described vertically or horizontally is ambiguous.

Next, as a second example, the handwriting direction detector 304 may calculate the number of downward vectors (in other words, vectors whose perpendicular component is negative) in a handwritten document out of a plurality of vectors corresponding to a plurality of strokes in a line. Based on the proportion of the downward vectors to all vectors in the line, the handwriting direction detector 304 may determine whether the characters in the line are written vertically or horizontally. When the proportion of the downward vectors to all vectors is greater than a threshold value, the handwriting direction detector 304 determines that the line is written horizontally. When the proportion of the downward vectors to all vectors is less than or equal to the threshold value, the handwriting direction detector 304 determines that the line is written vertically. In other words, when the direction of the line (the first line) is from left to right, and the proportion of the downward vectors to at least one vector which corresponds to at least one stroke and is the vector from the starting point to the end point of each stroke is greater than the threshold value, the handwriting direction detector 304 determines that the third direction, in which characters are described, is horizontal. When the direction of the line (the first direction) is from left to right, and the proportion of the downward vectors to the above at least one vector is less than or equal to the threshold value, the handwriting direction detector 304 determines that the third direction, in which characters are described, is vertical. The threshold value is set to, for example, 0.5. In this case, the handwriting direction detector 304 determines which vectors, downward vectors or upward vectors, are more included in a plurality of vectors corresponding to a plurality of strokes in the line. The threshold value may be adjusted in advance such that the determination accuracy is high.

The handwriting direction detector 304 may calculate the number of right-downward vectors in a written document out of a plurality of vectors corresponding to a plurality of strokes in a line. Based on the proportion of the right-downward vectors to all vectors in the line, the handwriting direction detector 304 may determine whether the characters in the line are written vertically or horizontally.

When the proportion of the downward vectors to all vectors is within a predetermined range including the threshold value (for example, within the range from +0.1 to −0.1 of the threshold value), the handwriting direction detector 304 may determine whether the line is written vertically or horizontally in consideration of whether the other lines in the handwritten document are written vertically or horizontally. With this configuration, for example, when the number of downward vectors is substantially equal to the number of upward vectors, it is possible to reduce errors of determination of whether the characters in the line are described vertically or horizontally.

As a third example, in addition to at least one vector which corresponds to at least one stroke in a line and is the vector from the starting point to the end point of each stroke, the handwriting direction detector 304 uses the vector from the end point of a first stroke out of the above at least one stroke to the starting point of a second stroke following the first stroke (hereinafter, referred to as the vector between strokes) in order to determine whether the characters in the line are written vertically or horizontally. In sum, the handwriting direction detector 304 determines the third direction, in which characters are described. This third direction is determined by using the first direction, the second direction and a fourth direction. The first direction is the direction of the line. The second direction is the direction of at least one stroke corresponding to the vector from the starting point to the end point of each stroke. The fourth direction corresponds to the vector from the end point of the first stroke out of the above at least one stroke to the starting point of the second stroke following the first stroke.

More specifically, the handwriting direction detector 304 calculates the vector from the starting point to the end point of each stroke in the line. The handwriting direction detector 304 uses adjacent strokes in the line in order to calculate the vector between the strokes from the end point of the earlier first stroke to the starting point of the second stroke following the first stroke. The handwriting direction detector 304 calculates the vector in which the calculated vector between the strokes is inverted up and down (in the perpendicular direction).

The handwriting direction detector 304 calculates a resultant vector by combining the calculated vectors corresponding to the strokes in the line respectively, and the up-and-down-inverted vectors between strokes. When calculating the resultant vector, the handwriting direction detector 304 may combine the vectors by weighting the vectors corresponding to the strokes in the line respectively with weight based on the length or the feature of shape of the corresponding strokes, and weighting the vectors between strokes with weight based on the size of the vectors between strokes. In the same manner as the first example, based on the direction of the calculated resultant vector, the handwriting direction detector 304 determines whether the characters in the line are described vertically or horizontally.

The vector between strokes is the vector from the position in which the handwriting input of one stroke is completed to the position in which the handwriting input of the next stroke is started. For example, in a horizontal line handwritten from left to right, in many cases, after the handwriting input of one stoke is completed on the lower side of the line, the handwriting input of the next stroke is started on the upper side of the line. In a vertical line handwritten from top to bottom, in many cases, after the handwriting input of one stroke is completed on the upper side of the line, the handwriting input of the next stroke is started on the lower side of the line. Because of this feature, if the resultant vector is calculated by further using the up-and-down-inverted vectors between strokes, it is possible to reduce errors of determination of whether the characters in the line are described vertically or horizontally.

When the vector between strokes is large (greater than a threshold value), the stroke starting from the end point of the vector between strokes is highly likely the initial stroke of a character. Therefore, the handwriting direction detector 304 may detect the initial stroke of a character on the basis that the vector between strokes is greater than or equal to a threshold value, and may determine whether the characters in the line are described vertically or horizontally based on the starting point of the initial stroke of the character. For example, the handwriting direction detector 304 determines that a line is written horizontally when most of starting points of initial strokes of characters are described on the upper side of the line. The handwriting direction detector 304 determines that a line is written vertically when most of starting points are described on the lower side of the line.

One of methods for determining whether characters in a line are described vertically or horizontally uses the ratio of width to height of the rectangle surrounding a stroke in the line. In this method, when the width of the rectangle is longer than the height, the character in the line is determined as described horizontally. When the width of the rectangle is shorter than the height, the character in the line is determined as described vertically. However, in this method, for example, the characters in line 61 shown in FIG. 7 are erroneously determined as described horizontally because the width of the rectangle surrounding each stroke in line 61 is longer than the height.

In the present embodiment, this type of erroneous determination can be avoided by the configuration of the handwriting direction detector 304 described above. Thus, for example, it is possible to correctly determine that the characters in line 61 are described vertically. The handwriting direction detector 304 may be configured to determine whether a line is written vertically or horizontally based on the relationship between the direction in which the line is handwritten (the first direction) and at least one vector which corresponds to at least one stroke contained in the line and which is the vector from the staring point to the end point of each stroke (the second direction) without normalizing the line.

Next, the character recognition processor 305 recognizes the characters in the line based on whether the characters are described vertically or horizontally. For example, the character recognition processor 305 recognizes the characters in the line by using handwritten-character-dictionary data 402A stored in the storage medium 402.

More specifically, the character recognition processor 305 uses stroke data corresponding to handwritten strokes in order to calculate a feature amount (first feature amount) corresponding to the strokes. For example, the character recognition processor 305 calculates the feature amount based on whether the characters in the line are written vertically or horizontally, the shape and the order of the strokes, etc.

The character recognition processor 305 calculates the similarity between each character consisting of handwritten strokes and each character in the handwritten-character-dictionary data 402A by using the calculated first feature amount and a second feature amount corresponding to each character in the handwritten-character-dictionary data 402A. The handwritten-character-dictionary data 402A includes data of feature amounts of various handwritten characters, and is generated by, for example, analyzing stroke data corresponding to handwritten strokes, and handwritten document data 402B. For example, the handwritten-character-dictionary data 402A is generated depending on each user. Thus, the feature of characters handwritten by each user can be reflected.

For example, the character recognition processor 305 calculates the similarity between the first feature amount corresponding to handwritten strokes and each of a plurality of second feature amounts corresponding to a plurality of handwritten characters shown in the handwritten-character-dictionary data 402A. The character recognition processor 305 detects a character having the highest similarity out of the plurality of characters in the handwritten-character-dictionary data 402A, and determines the detected character as the character corresponding to the handwritten strokes.

By replacing strokes in a line by recognized characters, the document display processor 308 displays the characters. For example, the document display processor 308 is capable of displaying the recognized characters in a format suitable for an application program in which the characters are used (for example, word processing software, presentation software, and mailer).

The document storage processor 306 may store formatted document data including a recognized character in a predetermined format in the storage medium 402. The storage medium 402 is, for example, a storage device in the tablet computer 10. The stored formatted document data can be used in the above-described application program and the like.

The document storage processor 306 stores the generated stroke data (the stroke data temporarily stored in the working memory 401) as the handwritten document data 402B in the storage medium 402.

The document acquisition processor 307 reads arbitrary handwritten document data 402B which is already stored from the storage medium 402. The read handwritten document data 402B is sent to the document display processor 308. The document display processor 308 analyzes the handwritten document data 402B, and displays a document (page) including the path of each stroke shown by stroke data (time-series data) on the screen based on the analysis result.

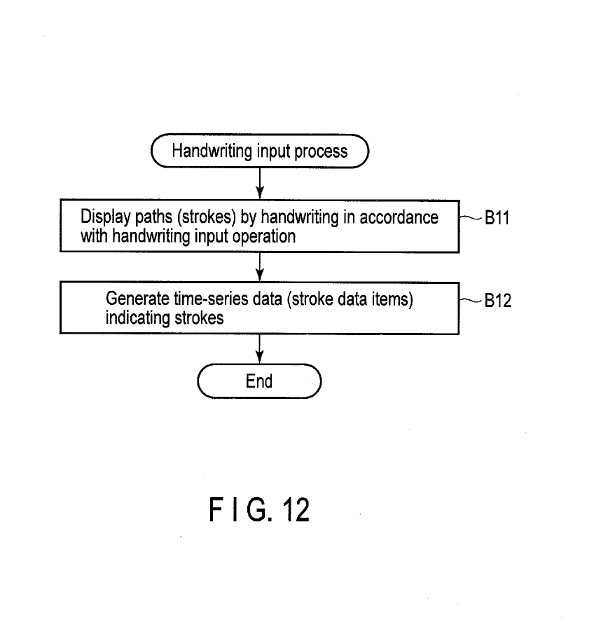

Next, examples of steps of a handwriting input process executed by the digital notebook application program 202 will be described referring to the flowchart of FIG. 12.

The path display processor 301 displays the paths (strokes) of movement of the stylus 100 by a handwriting input operation in a document (block B11). The time-series data generator 302 generates the above-described time-series data (in other words, stroke data items arranged in chronological order) based on coordinate sequences corresponding to the paths by the handwriting input operation, and temporarily stores the time-series data in the working memory 401 (block B12).

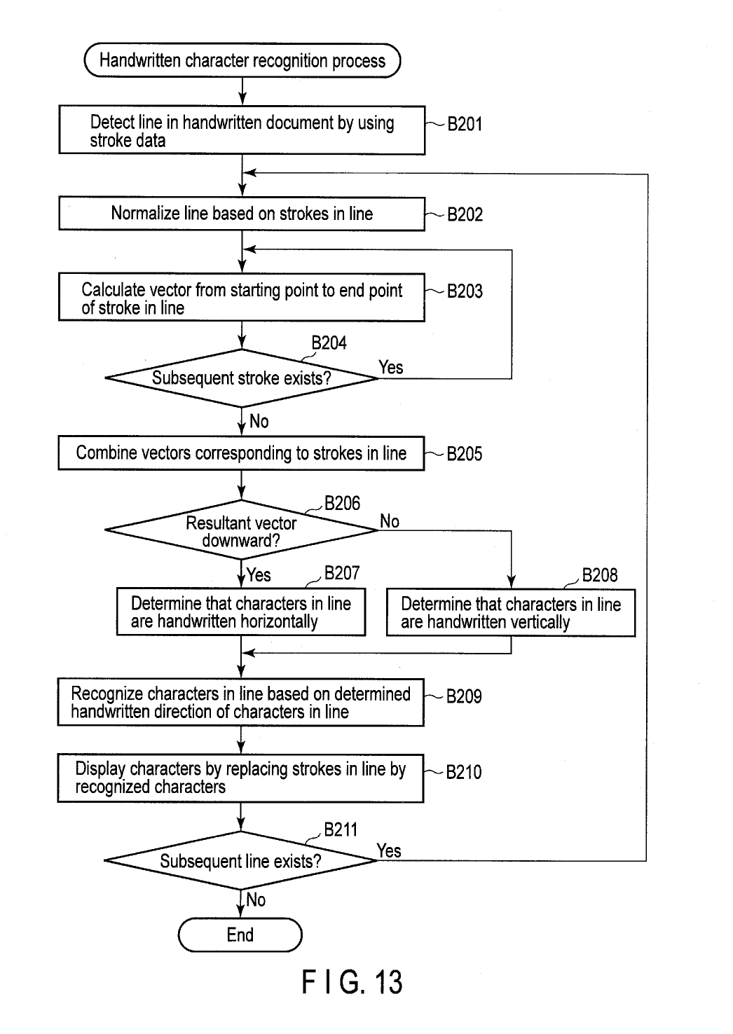

The flowchart of FIG. 13 shows examples of steps of a handwritten-character recognition process executed by the tablet computer 10. Hereinafter, it is assumed that a character in a displayed handwritten document is recognized.

First, the line detector 303 detects a line in a handwritten document by using stroke data corresponding to handwritten strokes (block B201). For example, when adjacent strokes in chronological order are within the range of a threshold value, the line detector 303 determines that the strokes are contained in one line.

Based on the strokes contained in the detected line, the handwriting direction detector 304 normalizes the line (block B202). By using coordinate data sequences corresponding to the strokes in chronological order in the line respectively, the handwriting direction detector 304 rotates the strokes such that the direction in which the line (each character in the line) is handwritten in the handwritten document is a predetermined direction (for example, a direction from left to right). For example, when the line (each character in the line) is handwritten from left to right, the strokes in the line are regarded as already normalized. Thus, the handwriting direction detector 304 does not rotate the strokes. For example, when the line (each character in the line) is handwritten from top to bottom, the handwriting direction detector 304 normalizes the line by rotating the strokes in the line 90 degrees counterclockwise.

Next, the handwriting direction detector 304 calculates the vector from the starting point to the end point of each stroke in the line (block B203). The handwriting direction detector 304 determines whether or not a subsequent stroke exists in the line (block B204). When a subsequent stroke exists in the line (YES in block B204), the process goes back to block B203 in order to calculate the vector from the starting point to the end point of the subsequent stroke. When no subsequent stroke exists in the line (NO in block B204), the handwriting direction detector 304 calculates a resultant vector by combining a plurality of vectors corresponding to a plurality of strokes in the line (block B205).

The handwriting direction detector 304 determines whether or not the calculated resultant vector is downward in the handwritten document (block B206). When the resultant vector is downward (YES in block B206), the handwriting direction detector 304 determines that the characters in the line are handwritten horizontally (block B207). When the resultant vector is not downward (NO in block B206), or in other words, when the resultant vector is upward, the handwriting direction detector 304 determines that the characters in the line are handwritten vertically (block B208).

Next, based on the determined handwritten direction of the characters in the line, the character recognition processor 305 recognizes the characters in the line (block B209). For example, the character recognition processor 305 recognizes the characters in the line by using the handwritten-character-dictionary data 402A stored in the storage medium 402. By replacing the strokes in the line by the recognized characters (the fonts corresponding to the character codes), the document display processor 308 displays the characters in the handwritten document (block B210).

The handwriting direction detector 304 determines whether or not a subsequent line exists in the handwritten document (block B211). When a subsequent line exists (YES in block B211), the process goes back to block B202 in order to execute the process for recognizing the characters in the subsequent line. When no subsequent line exists (NO in block B211), the process is terminated.

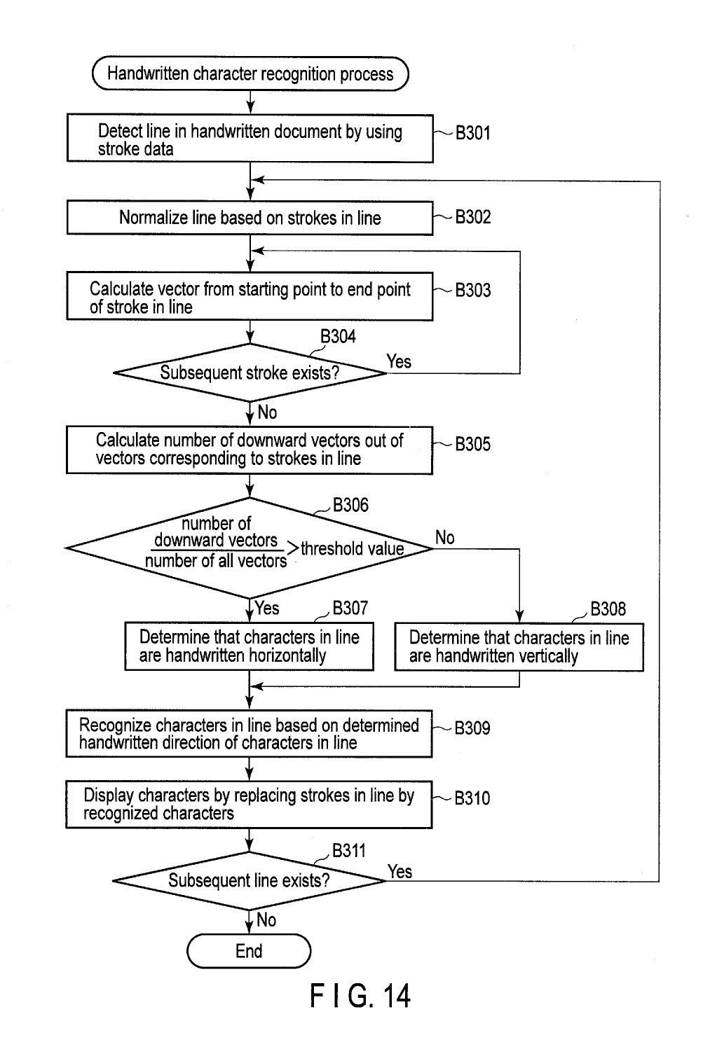

The flowchart of FIG. 14 shows other examples of steps of the handwritten character recognition process executed by the tablet computer 10. Hereinafter, it is assumed that a character in a displayed handwritten document is recognized.

First, the line detector 303 detects a line in a handwritten document by using stroke data corresponding to handwritten strokes (block B301). Based on the strokes contained in the detected line, the handwriting direction detector 304 normalizes the line (block B302).

Next, the handwriting direction detector 304 calculates the vector from the starting point to the end point of each stroke in the line (block B303). The handwriting direction detector 304 determines whether or not a subsequent stroke exists in the line (block B304). When a subsequent stroke exists in the line (YES in block B304), the process returns to block B303 in order to calculate the vector from the starting point to the end point of the subsequent stroke. When no subsequent stroke exists in the line (NO in block B304), the handwriting direction detector 304 calculates the number of downward vectors in the handwritten document out of a plurality of vectors corresponding to a plurality of strokes in the line (block B305).

The handwriting direction detector 304 determines whether or not the proportion of the downward vectors to all vectors is greater than a threshold value (block B306). When the proportion of the downward vectors to all vectors is greater than the threshold value (YES in block B306), the handwriting direction detector 304 determines that the characters in the line are handwritten horizontally (block B307). When the proportion of the downward vectors to all vectors is less than or equal to the threshold value (NO in block B306), the handwriting direction detector 304 determines that the characters in the line are handwritten vertically (block B308).

Next, based on the determined handwritten direction of the characters in the line, the character recognition processor 305 recognizes the characters in the line (block B309). By replacing the strokes in the line by the recognized characters, the document display processor 308 displays the characters in the handwritten document (block B310).

The handwriting direction detector 304 determines whether or not a subsequent line exits in the handwritten document (block B311). When a subsequent line exists (YES in block B311), the process returns to block B302 in order to execute the process for recognizing the characters in the subsequent line. When no subsequent line exits (NO in block B311), the process is terminated.

As stated above, in the present embodiment, a handwritten character can be accurately recognized. The path display processor 301 displays at least one stroke which is input in handwriting on the screen of the display 17 and which corresponds to one line containing a plurality of characters in a handwritten document. The line detector 303, the handwriting direction detector 304, the character recognition processor 305 and the document display processor 308 display a character corresponding to a recognition result of at least one stroke based on the third direction, in which the characters are described. The third direction is determined by using the first direction, in which a line is handwritten, and the second direction, which is the direction of at least one stroke corresponding to the vector from the starting point to the end point of each stroke.

By the above configuration, even when strokes are handwritten in a line at an arbitrary angle in a handwritten document, and the handwritten document includes both a line containing a vertically-described character and a line containing a horizontally-described character, it is possible to correctly display characters from strokes in each line.

All of the steps of the processes explained the flowcharts of FIG. 12 to FIG. 14 in the present embodiment can be executed by software. Therefore, by merely installing a program executing the steps into a computer through a computer-readable storage medium in which the program is stored, and executing the program, an effect similar to the present embodiment can be easily realized.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the inventions.

What is claimed is:

1. An electronic apparatus comprising:
circuitry configured to display strokes of one-line handwritten characters, wherein
the circuitry is further configured to display characters corresponding to a recognition result of the strokes in a third direction, the third direction determined based on a first direction of the one-line and a second direction determined based on at least one vector direction of at least one stroke.

2. The electronic apparatus of claim 1, wherein the circuitry is further configured to display the characters in the third direction, wherein the third direction is determined by using the second direction of a stroke corresponding to a vector from a starting point to an end point of the stroke when the first direction is normalized.

3. The electronic apparatus of claim 1, wherein
the circuitry is further configured to display the characters:
based on a result that the third direction is horizontal when the first direction is from left to right and the second direction is downward; and
based on a result that the third direction is vertical when the first direction is from left to right and the second direction is upward.

4. The electronic apparatus of claim 3, wherein
the circuitry is further configured to display the characters:
based on a result that the third direction is horizontal when the first direction is from left to right and the second direction is from up-left to down-right; and
based on a result that the third direction is vertical when the first direction is from left to right and the second direction is from down-left to up-right.

5. The electronic apparatus of claim 3, wherein
the circuitry is further configured to display the characters:
based on a result that the third direction is horizontal when the first direction is from left to right and the second direction is from up-left to down-right or from up-right to down-left; and
based on a result that the third direction is vertical when the first direction is from left to right and the second direction is from down-left to up-right or down-right to up-left.

6. The electronic apparatus of claim 1, wherein
the circuitry is further configured to display the characters on a basis that the third direction is:
horizontal when the first direction is from left to right, and a ratio of the number of the downward vectors to the number of all vectors corresponding to the one-line handwritten characters is greater than a threshold value, and
vertical when the first direction is from left to right, and a ratio of the number of the downward vectors to the number of all vectors corresponding to the one-line handwritten characters is less than or equal to the threshold value.

7. The electronic apparatus of claim 1, wherein
the third direction is determined based on the first direction, the second direction and a fourth direction, wherein the fourth direction is determined based on at least one vector direction defined by an end point of a handwritten stroke to a starting point of the following handwritten stroke.

8. A method comprising:
displaying strokes of one-line handwritten characters; and
displaying characters corresponding to a recognition result of the strokes in a third direction, the third direction determined based on a first direction of the one-line and a second direction determined based on at least one vector direction of at least one stroke.

9. The method of claim 8, further comprising:
displaying the characters in the third direction, wherein the third direction is determined by using the second direction of a stroke corresponding to a vector from a starting point to an end point of the stroke when the first direction is normalized.

10. The method of claim 8, further comprising:
displaying the characters:
based on a result that the third direction is horizontal when the first direction is from left to right and the second direction is downward; and
based on a result that the third direction is vertical when the first direction is from left to right and the second direction is upward.

11. The method of claim 8, wherein
the third direction is determined based on the first direction, the second direction and a fourth direction, wherein the fourth direction is determined based on at least one vector direction defined by an end point of a handwritten stroke to a starting point of the following handwritten stroke.

12. A non-transitory computer-readable medium having a plurality of executable instructions configured to cause one or more computers to perform a character recognition, the computer-readable medium comprising:
displaying strokes of one-line handwritten characters; and
displaying characters corresponding to a recognition result of the strokes in a third direction, the third direction determined based on a first direction of the one-line and a second direction determined based on at least one vector direction of at least one stroke.

13. The computer-readable medium of claim 12, further comprising:
displaying the characters in the third direction, wherein the third direction is determined by using the second direction of a stroke corresponding to a vector from a starting point to an end point of the stroke when the first direction is normalized.

14. The computer-readable medium of claim 12, further comprising displaying the characters:
based on a result that the third direction is horizontal when the first direction is from left to right and the second direction is downward; and
based on a result that the third direction is vertical when the first direction is from left to right and the second direction is upward.

15. The computer-readable medium of claim 12, wherein the third direction is determined based on the first direction, the second direction and a fourth direction, wherein the fourth direction is determined based on at least one vector direction defined by an end point of a handwritten stroke to a starting point of the following handwritten stroke.
